(19) United States
(12) Patent Application Publication
(10) Pub. No.: US 2021/0061091 A1
(43) Pub. Date: Mar. 4, 2021

(54) VEHICLE FUEL DOOR BIASING SYSTEMS

(71) Applicant: FORD GLOBAL TECHNOLOGIES, LLC, Dearborn, MI (US)

(72) Inventors: David Martin, Dearborn, MI (US); Brent Edward Sealy, Canton, MI (US); Roshini Venkatesh, Canton, MI (US)

(21) Appl. No.: 16/552,322

(22) Filed: Aug. 27, 2019

(51) Int. Cl. B60K 15/05; E05F 15/60; E05F 15/71

(52) U.S. Cl. CPC B60K 15/05; E05F 15/60; E05F 15/71; E05Y 2900/534; B60K 2015/0561; E05Y 2201/434; E05Y 2400/32; B60K 2015/053

(57) ABSTRACT

This disclosure is directed to vehicle fuel systems that include door biasing systems for controlling the opening and/or closing of a fuel door of the fuel systems. In a first embodiment, a dual spring door biasing system controls the operation of the fuel door. In a second embodiment, a wind closed door biasing system controls the operation of the fuel door.

### TECHNICAL FIELD

This disclosure relates to vehicle fuel systems, and more particularly to fuel door biasing systems for controlling the operation of fuel system doors.

### BACKGROUND

Many automotive vehicles include fuel systems. A fuel door assembly of the fuel systems provides access to a fuel inlet conduit for refueling the vehicle.

### SUMMARY

A fuel system for a vehicle according to an exemplary aspect of the present disclosure includes, among other things, a fuel door and a door biasing system configured to control movement of the fuel door. The door biasing system includes a first spring configured to control the movement of the fuel door to an open position and a second spring configured to control the movement of the fuel door to a closed position.

In a further non-limiting embodiment of the foregoing fuel system, the first spring includes a first spring force and the second spring includes a second spring force that is smaller than the first spring force.

In a further non-limiting embodiment of either of the foregoing fuel systems, the first spring and the second spring are electromechanical torsion springs.

In a further non-limiting embodiment of any of the foregoing fuel systems, the first spring and the second spring are shape memory alloy springs.

In a further non-limiting embodiment of any of the foregoing fuel systems, a control system is configured to command the fuel door to the open position by applying a first operating voltage to the first spring.

In a further non-limiting embodiment of any of the foregoing fuel systems, the control system is configured to command the fuel door to the closed position by applying a second operating voltage to the second spring. The first operating voltage is larger than the second operating voltage.

In a further non-limiting embodiment of any of the foregoing fuel systems, an actuator is configured to apply either a first operating voltage to the first spring for opening the fuel door or a second operating voltage to the second spring for closing the fuel door.

In a further non-limiting embodiment of any of the foregoing fuel systems, the actuator is an electromagnetic switch.

In a further non-limiting embodiment of any of the foregoing fuel systems, a control system is configured to command the actuator to apply either the first operating voltage or the second operating voltage.

In a further non-limiting embodiment of any of the foregoing fuel systems, the fuel system is a Non-Integrated Refueling Canister Only System (NIRCOS).

A fuel system for a vehicle according to another exemplary aspect of the present disclosure includes, among other things, a fuel door and a door biasing system configured to control movement of the fuel door. The door biasing system includes a hinge spring having a spring force that is about equal to a wind force that is applied against the fuel door when the vehicle is traveling at a predefined speed.

In a further non-limiting embodiment of the foregoing fuel system, the predefined speed is between about 20 miles per hour and about 40 miles per hour.

In a further non-limiting embodiment of either of the foregoing fuel systems, the spring force of the hinge spring is overcome by the wind force when the vehicle is traveling at the predefined speed, thereby automatically moving the fuel door from an open position to a closed position.

In a further non-limiting embodiment of any of the foregoing fuel systems, the movement from the open position to the closed position occurs without any required user input.

In a further non-limiting embodiment of any of the foregoing fuel systems, the door biasing system includes a solenoid having a body and a piston that is movable relative to the body.

In a further non-limiting embodiment of any of the foregoing fuel systems, the piston is movable into a detent of a fuel door assembly to lock a positioning of the fuel door.

In a further non-limiting embodiment of any of the foregoing fuel systems, the piston is movable out of the detent to unlock the positioning of the fuel door.

In a further non-limiting embodiment of any of the foregoing fuel systems, the detent is formed in a pivot pin of a hinge assembly of the fuel door assembly.

In a further non-limiting embodiment of any of the foregoing fuel systems, a control system is configured to command movement of the piston between a first position in which the piston is received in a detent and a second position in which the piston is not received in the detent.

In a further non-limiting embodiment of any of the foregoing fuel systems, the fuel system is a Non-Integrated Refueling Canister Only System (NIRCOS).

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a vehicle equipped with a fuel system.

FIG. 2 illustrates a fuel door assembly of the fuel system of the vehicle of FIG. 1.

FIG. 3 illustrates a fuel door biasing system according to an embodiment of this disclosure.

FIG. 4 illustrates a fuel door biasing system according to another embodiment of this disclosure.

FIGS. 5A and 5B illustrate a fuel door biasing system according to yet another embodiment of this disclosure.

FIG. 5C illustrates a fuel door that can be controlled by the fuel door biasing system of FIGS. 5A and 5B.

FIGS. 5D and 5E schematically illustrate the functionality of a solenoid of the fuel door biasing system of FIGS. 5A and 5B.

### DETAILED DESCRIPTION

This disclosure is directed to vehicle fuel systems that include door biasing systems for controlling the opening and/or closing of a fuel door of the fuel systems. In a first embodiment, a dual spring door biasing system controls the operation of the fuel door. In a second embodiment, a wind closed door biasing system controls the operation of the fuel door. These and other features of this disclosure are described in greater detail below.

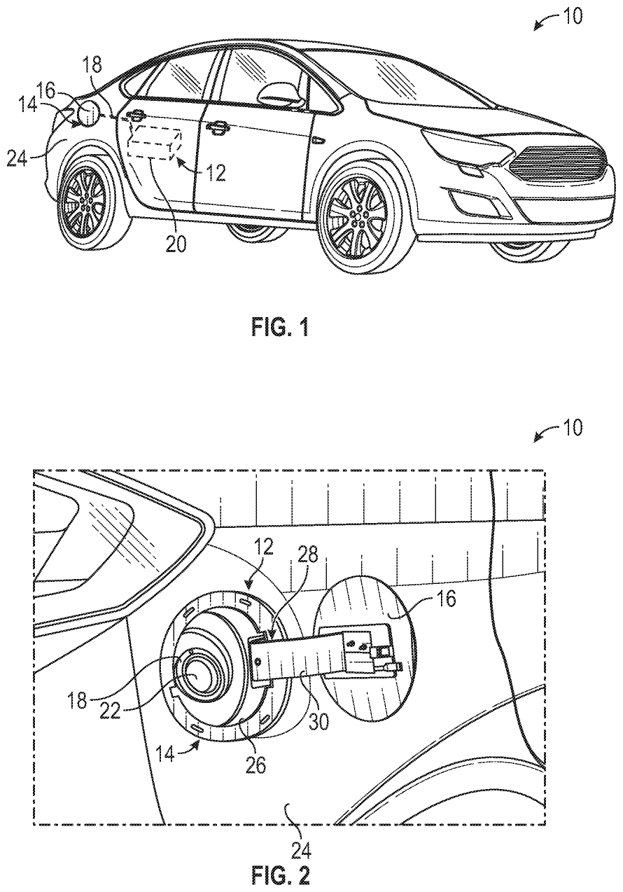

FIGS. 1 and 2 schematically illustrate a vehicle 10. The vehicle 10 could be a car, a truck, a van, a sport utility vehicle, or any other type of vehicle. The vehicle 10 could also be a conventional, internal combustion engine powered vehicle, a traction battery powered hybrid electric vehicle (HEV), a plug-in hybrid electric vehicle (PHEV), etc.

Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component.

The vehicle 10 includes a fuel system 12. The fuel system 12 may include, among various other components, a fuel door assembly 14 that includes a fuel door 16, a fuel inlet conduit 18, and a fuel tank 20. The fuel inlet conduit 18 includes an inlet opening 22. The fuel inlet conduit 18 may extend from the inlet opening 22 to the fuel tank 20.

The fuel door 16 is shown in a closed position in FIG. 1 and is shown in an open position in FIG. 2. When the fuel door 16 is rotated to the closed position, the fuel door 16 is substantially flush to a vehicle body component, such as a rear side panel 24 of the vehicle 10, for example.

The fuel door assembly 14 may include a housing 26 that circumferentially surrounds the inlet opening 22 of the fuel inlet conduit 18. The housing 26 may extend from the fuel inlet conduit 18 to the rear side panel 24 to cover a gap between the fuel inlet conduit 18 and the vehicle body.

The fuel door assembly 14 may additionally include a hinge assembly 28 having a hinge arm 30. The hinge assembly 28 may be connected to both the fuel door 16 and the housing 26 to control movement of the fuel door 16 between the open and closed positions relative to the housing 26.

The fuel system 12 may be a capless fuel system, which, for purposes of this disclosure, means that no separate cap is removably secured relative to the fuel inlet conduit 18 to seal and cover the inlet opening 22.

To refuel the fuel tank 20, a fuel dispensing nozzle (not shown) may be inserted through the inlet opening 22 of the fuel inlet conduit 18. Fuel can then be delivered from a fuel supply, through the fuel dispensing nozzle, into the fuel inlet conduit 18, and ultimately into the fuel tank 20.

In an embodiment, the fuel system 12 is designed to retain fuel vapors to meet evaporative emissions requirements. The fuel system 12 may be a Non-Integrated Refueling Canister Only System (NIRCOS). As a result, the fuel system 12 can achieve vapor pressures and vacuum levels higher than conventional fuel systems. However, the teachings of this disclosure are not limited to NIRCOS fuel systems and could apply to any fuel system for any vehicle.

The fuel system 12 can incorporate a pressure management system that ensures that a pressure within the fuel tank 20 is maintained within a particular threshold range. Adjusting the pressure within the fuel tank 20 may be required prior to refueling the fuel tank 20. For example, if the pressure is too high, reducing the pressure may be needed prior to refueling to lessen the potential for fuel vapors escaping from the fuel system 12 through the inlet opening 22. Alternatively, if the pressure is too low, increasing the pressure may be required prior to refueling to lessen the potential for a vacuum drawing contaminants into the fuel system 12 through the inlet opening 22. In an embodiment, adjusting the pressure within the fuel tank 20 can require from three to fifteen seconds. After the pressure is appropriately adjusted, the user can begin to refuel the fuel tank 20.

Users may not always successfully close the fuel door 16 after refueling the fuel tank 20, thereby preventing the fuel tank 20 from properly depressurizing. This could cause the fuel system 12 to vent the fuel vapors to the atmosphere and lead to generating a check engine light error within the vehicle 10. Accordingly, door biasing systems that provide improved control of the operation of the fuel door 16 are proposed within this disclosure.

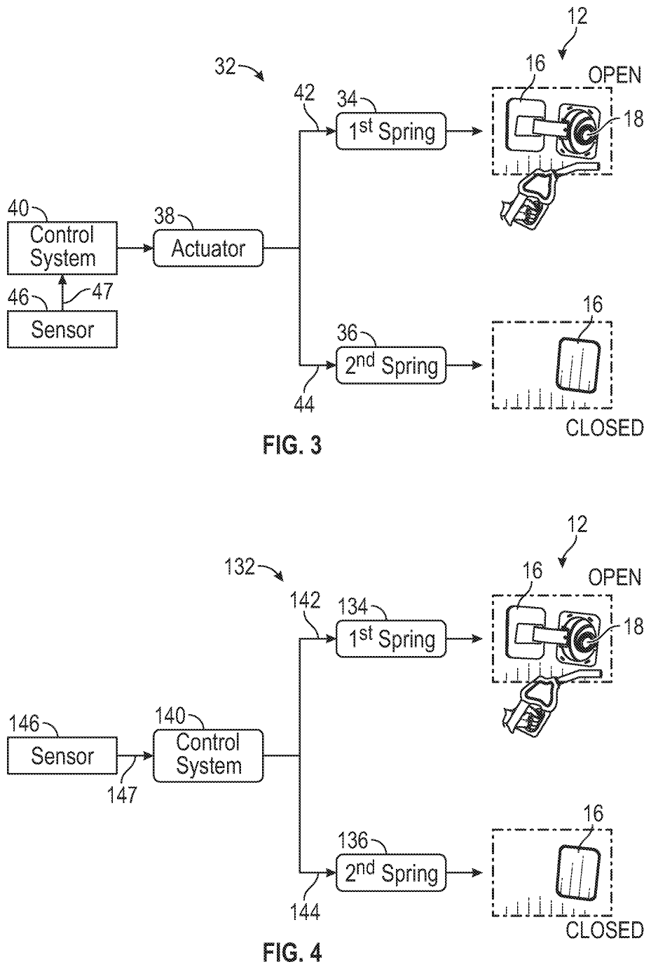

A first exemplary door biasing system 32 for controlling the operation of the fuel door 16 of the fuel system 12 is schematically illustrated in FIG. 3. The door biasing system 32 may include a first spring 34, a second spring 36, an actuator 38, and a control system 40.

The first spring 34 may be configured to control the opening of the fuel door 16, and the second spring 36 may be configured to control the closing of the fuel door 16. In an embodiment, the first spring 34 includes a first spring force and the second spring 36 includes a second spring force that is smaller than the first spring force. Therefore, the amount of force required to open the fuel door 16 is larger than the amount of force required to close the fuel door 16.

In an embodiment, the first spring 34 and the second spring 36 are electromechanical torsion springs. However, other electromechanical springs are also contemplated within the scope of this disclosure.

In an embodiment, the actuator 38 is a switch, such as an electromagnetic switch. The actuator 38 may be controlled by the control system 40 to switch between applying an operating voltage to either the first spring 34 for opening the fuel door 16 or to the second spring 36 for closing the fuel door 16.

The actuator 38 is controlled by the control system 40, which is operably linked to the fuel tank 20 or sensors that monitor a pressure of the fuel tank 20 and/or other areas of the fuel system 12. The control system 40 may include one or more control modules equipped with executable instructions for interfacing with and commanding operation of the various components of the fuel system 12. Each such control module may include a processing unit and non-transitory memory for executing the various control strategies of the components of the fuel system 12. The processing unit, in an embodiment, is configured to execute one or more programs stored in the memory of the control system 40.

A first exemplary program, when executed, may be employed to initiate a fuel tank pressurization/depressurization sequence and to command movement of the fuel door 16 to the open position after the pressurization/depressurization is completed. The control system 40 may command the fuel door 16 to the open position by first positioning the actuator 38 in a first position (e.g., by moving a switch to the first position associated with the first spring 34) and then applying a first operating voltage 42 to the first spring 34. The first operating voltage 42 energizes the first spring 34, thereby forcing the first spring 34 to open the fuel door 16.

A second exemplary program of the control system 40, when executed, may be employed to close the fuel door 16 after the refueling event has been completed. The control system 40 may command the fuel door 16 to the closed position by first positioning the actuator 38 in a second position (e.g., by moving a switch to the second position associated with the second spring 36) and then applying a second operating voltage 44 to the second spring 36. The second operating voltage 44 energizes the second spring 36, thereby forcing the second spring 36 to close the fuel door 16.

In an embodiment, the second operating voltage 44 associated with the second spring 36 is a lower voltage than the first operating voltage 42 associated with the first spring 34. Therefore, a smaller force is required to close the fuel door 16 via the second spring 36 as compared to the force required to open the fuel door 16 via the first spring 34. This can result in eliminating the need to set a check engine light error in situations where the user inadvertently leaves the fuel door 16 open after refueling. Moreover, because the actuator 38 can be positioned to apply either the first operating voltage 42 or the second operating voltage 44, the first spring 34 and the second spring 36 can be controlled independently from one another for opening and closing the fuel door 16, respectively.

In an embodiment, the control system 40 is operably linked to both the actuator 38 and to a sensor 46 of the fuel system 12. Signals from the sensor 46 can provide inputs to the control system 40 for indicating that the user desires to refuel the vehicle 10. For example, the sensor 46 may provide an input signal 47 to the control system 40 indicating that the user has pushed a fuel door opening button located inside a passenger cabin or elsewhere on the vehicle 10 or otherwise has indicated a desire to refuel.

In response to receiving the signal(s) 47 from the sensor 46, the control system 40 can initiate a depressurization or vacuum reduction routine to bring the pressure of the fuel tank 20 to be within a range acceptable for refueling. The fuel door 16 is held closed by the door biasing system 32 during the depressurization. After bringing the pressure within a predefined pressure range, the control system 40 may actuate the actuator 38, thereby causing the first spring 34 to move the fuel door 16 and hold the fuel door 16 in the open position.

FIG. 4 schematically illustrates another exemplary door biasing system 132 for controlling the operation of the fuel door 16 of the fuel system 12 of FIGS. 1-2. The door biasing system 132 may include a first spring 134, a second spring 136, and a control system 140.

The first spring 134 may be configured to control the opening of the fuel door 16, and the second spring 136 may be configured to control the closing of the fuel door 16. In an embodiment, the first spring 134 includes a first spring force and the second spring 136 includes a second spring force that is smaller than the first spring force. Therefore, the amount of force required to open the fuel door 16 is larger than the amount of force required to close the fuel door 16.

In an embodiment, the first spring 134 and the second spring 136 are shape memory alloy springs. The first spring 134 and the second spring 136 may be made of Nitinol or any other shape memory material or combinations of shape memory materials.

The control system 140 may be operably linked to the fuel tank 20 or sensors that monitor a pressure of the fuel tank 20 and/or other areas of the fuel system 12. The control system 140 may include a processing unit that is configured to execute one or more programs stored in a memory device.

A first exemplary program, when executed, may be employed to initiate a fuel tank pressurization/depressurization sequence and to command movement of the fuel door 16 to the open position after the pressurization/depressurization is completed. The control system 140 may command the fuel door 16 to the open position by applying a first operating voltage 142 to the first spring 134. The first operating voltage 142 energizes the first spring 134 to force the first spring 134 to alter its shape, thereby opening the fuel door 16. Thus, in this embodiment, the control system 140 itself acts as an actuator.

A second exemplary program, when executed, may be employed to close the fuel door 16 after the refueling event has been completed. The control system 140 may command the fuel door 16 to the closed position by applying a second operating voltage 144 to the second spring 136. The second operating voltage 144 energizes the second spring 136 to force the second spring 136 to alter its shape, thereby closing the fuel door 16.

In an embodiment, the control system 140 stops applying the first operating voltage 142 prior to applying the second operating voltage 144. Therefore, the first operating voltage 142 and the second operating voltage 144 are applied sequentially rather than simultaneously. Once the first operating voltage 142 or the second operating voltage 144 are no longer applied, the first spring 134 and the second spring 136 may return to their original shapes.

In another embodiment, the second operating voltage 144 associated with the second spring 136 is a lower voltage than the first operating voltage 142 associated with the first spring 134. Therefore, a smaller force is required to close the fuel door 16 via the second spring 136 as compared to the force required to open the fuel door 16 via the first spring 134. This may result in eliminating the need to set a check engine light error in situations where the user inadvertently leaves the fuel door 16 open after refueling. Moreover, via the control system 140, the first spring 134 and the second spring 136 can be controlled independently from one another for opening and closing the fuel door 16, respectively.

The control system 140 may be operably linked to a sensor 146 of the fuel system 12. Signals 147 from the sensor 146 can provide inputs to the control system 140 for indicating that the user desires to refuel the vehicle 10. In response to receiving the signal(s) 147 from the sensor 146, the control system 140 can initiate a depressurization or vacuum reduction routine to bring the pressure of the fuel tank 20 to be within a range acceptable for refueling. The fuel door 16 is held closed during the depressurization. After bringing the pressure to within a predefined pressure range, the control system 140 may apply the first operating voltage 142 to the first spring 134 in order to move and hold the fuel door 16 in the open position.

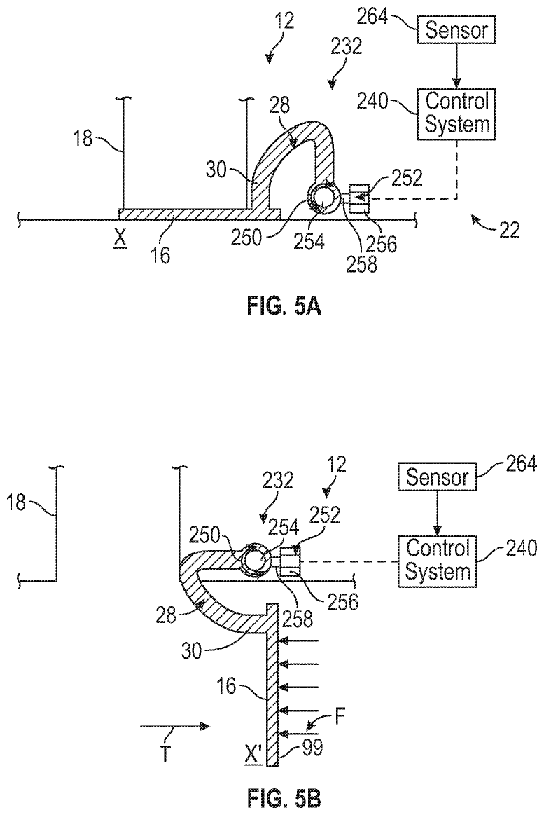

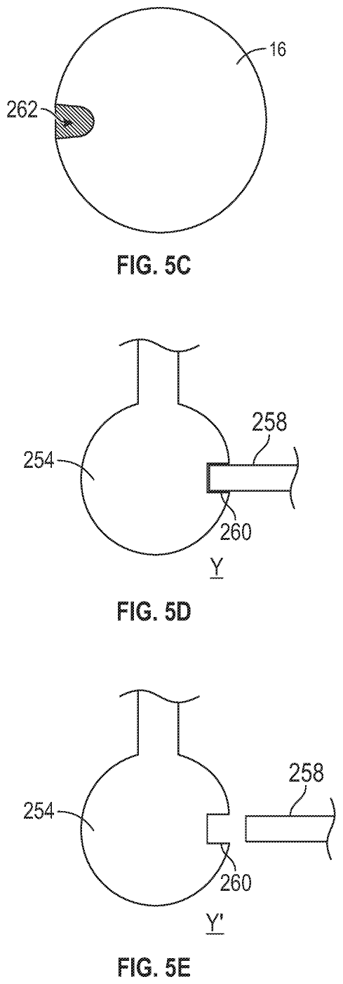

FIGS. 5A and 5B illustrate yet another exemplary door biasing system 232 for controlling the operation of a fuel door 16 of a fuel system 12. The fuel door 16 is shown in a closed positon X in FIG. 5A and is shown in an open position X′ in FIG. 5B.

The exemplary door biasing system 232 may include a hinge spring 250, a solenoid 252, and a control system 240. The hinge spring 250 may be received over a pivot pin 254 of the hinge assembly 28. The pivot pin 254 is operably connected to the hinge arm 30 and is configured to guide movement of the fuel door 16 between the closed position X and the open position X′.

The hinge spring 250 includes a spring force. The spring force of the hinge spring 250 may be specifically engineered to be equal to or slightly less than a wind force F that is applied to the fuel door 16 when the vehicle 10 reaches a predefined speed. The wind force F is generally applied against an outward face 99 of the fuel door 16 in a direction that is opposite to a direction of travel T of the vehicle 10. Therefore, once the vehicle 10 reaches the predefined speed, the wind force F may overcome the spring force of the hinge spring 250, thereby moving the fuel door 16 from the open position X′ back to the closed position X. This movement can be achieved solely by the aerodynamics of the vehicle 10 when traveling at the predefined speed and is achieved without any required input or action by the vehicle user.

In an embodiment, the predefined speed at which the wind force F is calculated is between about 20 miles per hour (about 32 kilometers per hour) and about 40 miles per hour (about 64 kilometers per hour). However, the spring force of the hinge spring 250 could be matched to the wind force F at other vehicle speeds within the scope of this disclosure. In this disclosure, the term “about” means that the expressed quantities or ranges need not be exact but may be approximated and/or larger or smaller, reflecting acceptable tolerances, conversion factors, measurement error, etc.

The solenoid 252 of the door biasing system 232 may be controlled by the control system 240 to temporarily lock the positioning of the fuel door 16 (i.e., hold the fuel door 16 in either the closed position X or the open position X′). The solenoid 252 may include a body 256 and a piston 258. The solenoid 252 may be energized, such as in response to a command from the control system 240, to move the piston 258 relative to the body 256.

FIGS. 5D and 5E, with continued reference to FIGS. 5A and 5B, schematically illustrate the operation of the solenoid 252. The piston 258 of the solenoid 252 may be moved to a first position Y, shown in FIG. 5D. In the first position Y, the piston 258 is received within a detent 260 of the pivot pin 254 to lock a positioning of the fuel door 16. Although shown with respect to the pivot pin 254, the detent 260 could be positioned at other locations of the fuel door assembly. The fuel door 16 cannot be pivoted about the pivot pin 254 when the piston 258 is positioned within the detent 260.

The piston 258 may be also be moved to a second position Y′, shown in FIG. 5E. In the second position Y′, the piston 258 is removed from the detent 260 to unlock the positioning of the fuel door 16. The fuel door 16 is able to be pivoted about the pivot pin 254 when the piston 258 is removed from the detent 260.

In an embodiment, the piston 258 may be moved to the first position Y to lock the positioning of the fuel door 16 while the fuel tank 20 is depressurizing. In another embodiment, the piston 258 may be moved to the first position Y to lock the positioning of the fuel door 16 while the user is refueling the vehicle 10. The piston 258 may therefore prevent the fuel door 16 from being blown shut by wind forces that act on the fuel door 16 while the fuel door 16 is in the open position X′ and the vehicle 10 is stationary.

In another embodiment, the piston 258 may be commanded (e.g., via the control system 240) to the second position Y′ to unlock the positioning of the fuel door 16 after the depressurization routine of the fuel tank 20 has been completed. The user may then manually open the fuel door 16, such as by inserting their finger within a finger indent 262 (see FIG. 5C) of the fuel door 16 and then pivoting the fuel door 16 to the open position X′.

In yet another embodiment, the piston 258 may be automatically commanded to the second position Y′ to unlock the positioning of the fuel door 16, such as when the vehicle 10 is moved into a drive gear (i.e., transmission moved out of park), when the user closes the fuel door 16, etc. One or more sensors 264 may communicate with the control system 240 for indicating whether these conditions have been met.

The vehicle fuel systems of this disclosure include fuel door biasing systems for controlling the operation of the fuel doors. Among other potential benefits, the exemplary door biasing systems simplify and improve the vehicle refueling process, shorten fueling delays, eliminate check engine light errors, and reduce the potential for exposure to fuel vapors.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A fuel system for a vehicle, comprising:
a fuel door; and
a door biasing system configured to control movement of the fuel door,
wherein the door biasing system includes a first spring configured to control the movement of the fuel door to an open position and a second spring configured to control the movement of the fuel door to a closed position.

2. The fuel system as recited in claim 1, wherein the first spring includes a first spring force and the second spring includes a second spring force that is smaller than the first spring force.

3. The fuel system as recited in claim 1, wherein the first spring and the second spring are electromechanical torsion springs.

4. The fuel system as recited in claim 1, wherein the first spring and the second spring are shape memory alloy springs.

5. The fuel system as recited in claim 1, comprising a control system configured to command the fuel door to the open position by applying a first operating voltage to the first spring.

6. The fuel system as recited in claim 5, wherein the control system is configured to command the fuel door to the closed position by applying a second operating voltage to the second spring, wherein the first operating voltage is larger than the second operating voltage.

7. The fuel system as recited in claim 1, comprising an actuator configured to apply either a first operating voltage to the first spring for opening the fuel door or a second operating voltage to the second spring for closing the fuel door.

8. The fuel system as recited in claim 7, wherein the actuator is an electromagnetic switch.

9. The fuel system as recited in claim 7, comprising a control system that is configured to command the actuator to apply either the first operating voltage or the second operating voltage.

10. The fuel system as recited in claim 1, wherein the fuel system is a Non-Integrated Refueling Canister Only System (NIRCOS).

11. A fuel system for a vehicle, comprising:
a fuel door; and
a door biasing system configured to control movement of the fuel door,
wherein the door biasing system includes a hinge spring having a spring force that is about equal to a wind force that is applied against the fuel door when the vehicle is traveling at a predefined speed.

12. The fuel system as recited in claim 11, wherein the predefined speed is between about 20 miles per hour and about 40 miles per hour.

13. The fuel system as recited in claim 11, wherein the spring force of the hinge spring is overcome by the wind force when the vehicle is traveling at the predefined speed, thereby automatically moving the fuel door from an open position to a closed position.

14. The fuel system as recited in claim 13, wherein the movement from the open position to the closed position occurs without any required user input.

15. The fuel system as recited in claim 11, wherein the door biasing system includes a solenoid having a body and a piston that is movable relative to the body.

16. The fuel system as recited in claim 15, wherein the piston is movable into a detent of a fuel door assembly to lock a positioning of the fuel door.

17. The fuel system as recited in claim 16, wherein the piston is movable out of the detent to unlock the positioning of the fuel door.

18. The fuel system as recited in claim 16, wherein the detent is formed in a pivot pin of a hinge assembly of the fuel door assembly.

19. The fuel system as recited in claim 15, comprising a control system configured to command movement of the piston between a first position in which the piston is received in a detent and a second position in which the piston is not received in the detent.

20. The fuel system as recited in claim 11, wherein the fuel system is a Non-Integrated Refueling Canister Only System (NIRCOS).
